(19) United States
(12) Patent Application Publication
(10) Pub. No.: US 2005/0237478 A1
(43) Pub. Date: Oct. 27, 2005

(54) Eyewear with Semiprecious Gemstones

(75) Inventor: Steven R. Lipawsky, Coral Springs, FL (US)

Correspondence Address: Loren Donald Pearson, P.A., P.O.Box 402571, Miami Beach, FL, 33140-2571, US

(73) Assignee: SANS PAREIL, INC., Coral Springs, FL (US)

(21) Appl. No.: 10/709,271

(22) Filed: Apr. 26, 2004

(51) Int. Cl. G02C 11/02; G02C 1/00

(52) U.S. Cl. 351/51

(57) ABSTRACT

Semiprecious gemstones are inserted into sockets on temples of ophthalmic and plano eyewear (eyeglasses) and prescription and plano sunwear (sunglasses). The semiprecious gemstones decorate and provide value to the eyewear.

### BACKGROUND OF INVENTION

Semiprecious stones include a well-known list of gemstones. For purposes of this application, semiprecious gemstones include the following:

actinolite, adulite/chrysocolla, African bloodstone, African jade, agate, enydritic, amazonite agate, amber, amertrine, amethyst, amethyst lace, ammolite, antlerite, aquamarine, aragonite, azurite, black onyx, bloodstone/fancy jasper, blue agate, blue chalcedony, blue howlite, blue lacer agate, blue sand stone, Botswana agate, brazil agate, brecciated jasper, Burma jade, burned jade, calcite, calcite yellow, cape amethyst, carnelian, cat's eye/opal, charoite, Chinese turquoise, Chinese writing, chrosprase, citrine, citrite/smoky quartz, cloisonné, coffee jasper, coral, crazy lace agate, crystal, dalmetian, diopside, dumortierite, dyed lapis, dyed turquoise, epidote/unikite, fancy opaline jasper, flower jasper, fossil, garnet, golden sand stone, graphite, green agate, green & pink moss agate, green aventurine, green fluorite, hemachate, hematite, hicorite, honey amber, Indian agate, iolite, ivory, Korean jade, kunzite, kyanite, labradorite, lapis, layer agate, lepidolite, malachite, marquesite, meteorite/iron nickel, mica, moldavaite, moon stone, natural agate, nephrite. new jade/serpentine, night shine shell, obsidian, ocean jasper, peach flower, peacock shell, pearl, Peking jade, peridot, petrified wood, phantom quartz, picture jasper, pietersite, polka-dot agate, poppy jasper, purple fluorite, pyrite, rainbow fluorite, rainbow jasper, red aventurine, red jade/balas, red jasper, rhodocrosite (brown), rhodocrosite (pink), rhodolite, rhodonite, rock crystal, rose quartz, rubyzucite, rutilated, quartz, ryolite, sardonyx, skeletal crystal, sky blue agate, snow flakes, snow quartz, sodalite, strawberry quartz, sugilite, sunset jasper, super seven, tiger iron, tiger's eye, topaz/yellow jade, tourmaline, tree agate, tsavorite, turquoise, white howlite, white jade, yellow japser, yellow lace, and zebra jasper.

A gemstone (also known as a “gem”) is a mineral stone that can be cut and set as a jewel. There are approximately 3,500 mineral species in existence, of which under 200 can be considered gems. Of these, four have traditionally been called precious stones: diamonds, rubies, sapphires, and emeralds. The remainder have been labeled semiprecious stones.

Gemstone values are based on several factors, some of which include the following:

1. Rarity of the stone;

2. the cost of locating and extracting the stone;

3. Hardness of the stone, which is important for faceting and wearability;

4. Shine (i.e. high factor of refraction);

5. Beauty of color;

6. Size of finished stone measured in carats except pearls, which is a unit of quotation in gran=0.25 carats; and

7. Facets of the stone.

### SUMMARY OF INVENTION

It is accordingly an object of the invention to provide eyewear with semiprecious gemstones that overcomes the hereinafore-mentioned disadvantages of the heretofore-known devices of this general type.

With the foregoing and other objects in view, there is provided, in accordance with the invention, eyewear, including a temple having sockets formed therein, and a semiprecious stone set in said socket and connected to said temple. In accordance with another feature of the invention, glue can be disposed in the socket to attach the semiprecious stone to the stem.

This invention relates to affixing or integrating gemstones to various parts of eyeglasses and sunglasses by different methods. Previously, standard design variations consisted of the following: plastic materials that afforded color variations, and machining metal or plastic components to achieve a designed look.

In accordance with a further object of the invention, the eyewear can be either ophthalmic or plano eyeglasses.

In accordance with a further object of the invention, the eyewear can be prescription or plano sunglasses.

The application of gemstones to eyewear and sunglasses provides an innovative and unique design concept that achieves the objects.

The eyewear with gemstones provides intrinsic value. The eyewear creates a unique look in terms of color and mass and a unique distinction from other eyewear. The eyewear according to the invention creates a unique attractive combination in eyewear and sunwear. The invention successfully transcends jewelry to eyewear and sunwear. It is, therefore, an object of this innovative design concept to provide a unique look and transcend jewelry to eyewear and sunwear for the consumer.

Other features that are considered as characteristic for the invention are set forth in the appended claims.

Although the invention is illustrated and described herein as embodied in eyewear with semiprecious gemstones, it is, nevertheless, not intended to be limited to the details shown since various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF DRAWINGS

FIG. 1A is a diagrammatic front side view of a first embodiment of eyewear according to the invention;

FIG. 1B is a right side view of the eyewear shown in FIG. 1A;

FIG. 1C is a partial top side view of the eyewear shown in FIG. 1A;

FIG. 1D is a sectional front side view of the eyewear shown in FIG. 1A taken along line A-A in FIG. 1B;

FIG. 1E is an exploded, partial, perspective view of the eyewear shown in FIG. 1A;

FIG. 1F is a partial perspective view of the eyewear shown in FIG. 1A;

FIG. 2A is a diagrammatic front side view of a second embodiment of eyewear according to the invention;

FIG. 2B is a right side view of the eyewear shown in FIG. 2A;

FIG. 2C is a partial top side view of the eyewear shown in FIG. 2A;

FIG. 2D is a sectional front side view of the eyewear shown in FIG. 2A taken along line A-A in FIG. 2B;

FIG. 2E is an exploded, partial, perspective view of the eyewear shown in FIG. 2A;

FIG. 2F is a partial perspective view of the eyewear shown in FIG. 2A;

FIG. 3A is a diagrammatic front side view of a third embodiment of eyewear according to the invention;

FIG. 3B is a right side view of the eyewear shown in FIG. 3A;

FIG. 3C is a sectional front side view of the eyewear shown in FIG. 3A taken along line A-A in FIG. 3B;

FIG. 3D is an exploded, partial, perspective view of the eyewear shown in FIG. 3A;

FIG. 3E is an partial perspective view of the eyewear shown in FIG. 3A;

FIG. 4A is a diagrammatic front side view of a fourth embodiment of eyewear according to the invention;

FIG. 4B is a right side view of the eyewear shown in FIG. 4A;

FIG. 4C is a sectional front side view of the eyewear shown in FIG. 4A taken along line A-A in FIG. 4B;

FIG. 4D is an exploded, partial, perspective view of the eyewear shown in FIG. 4A; and

FIG. 4E is a partial perspective view of the eyewear shown in FIG. FIG. 4A.

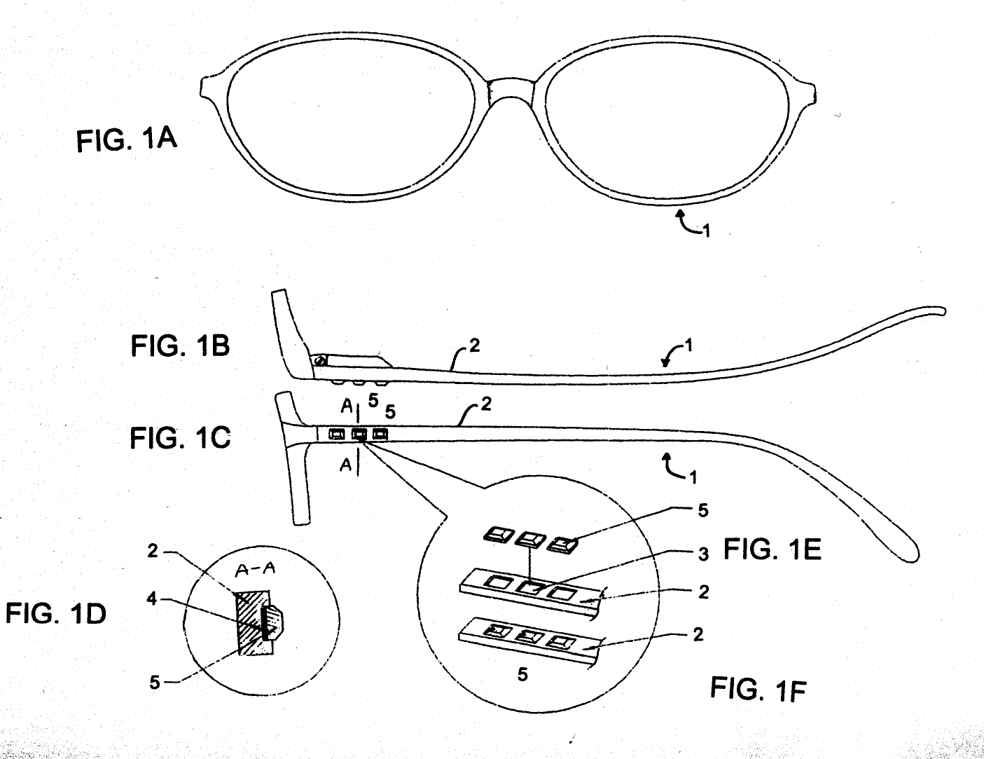

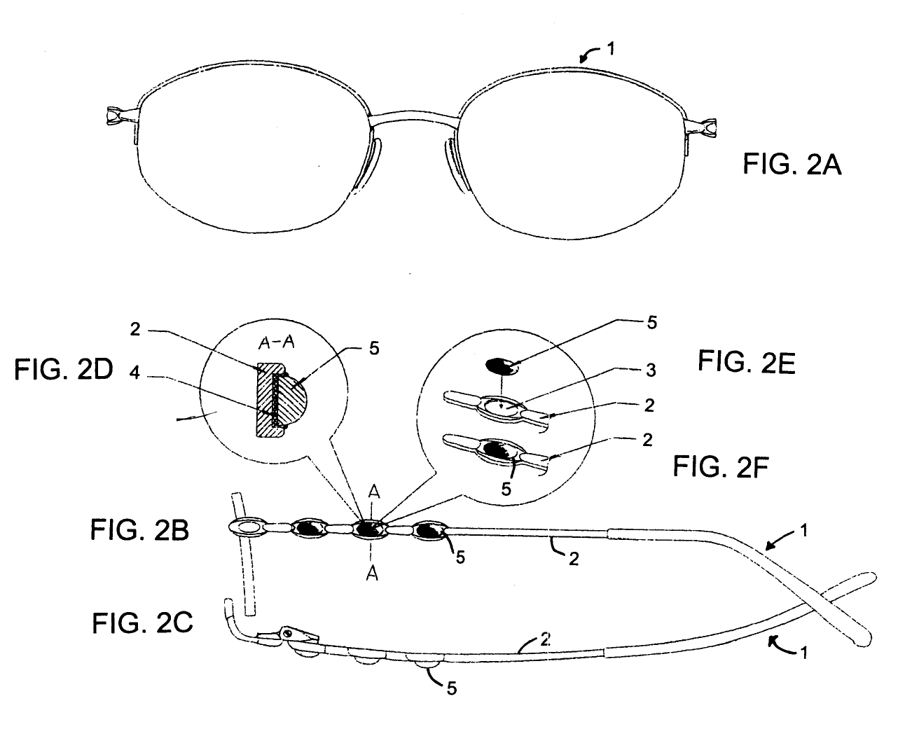

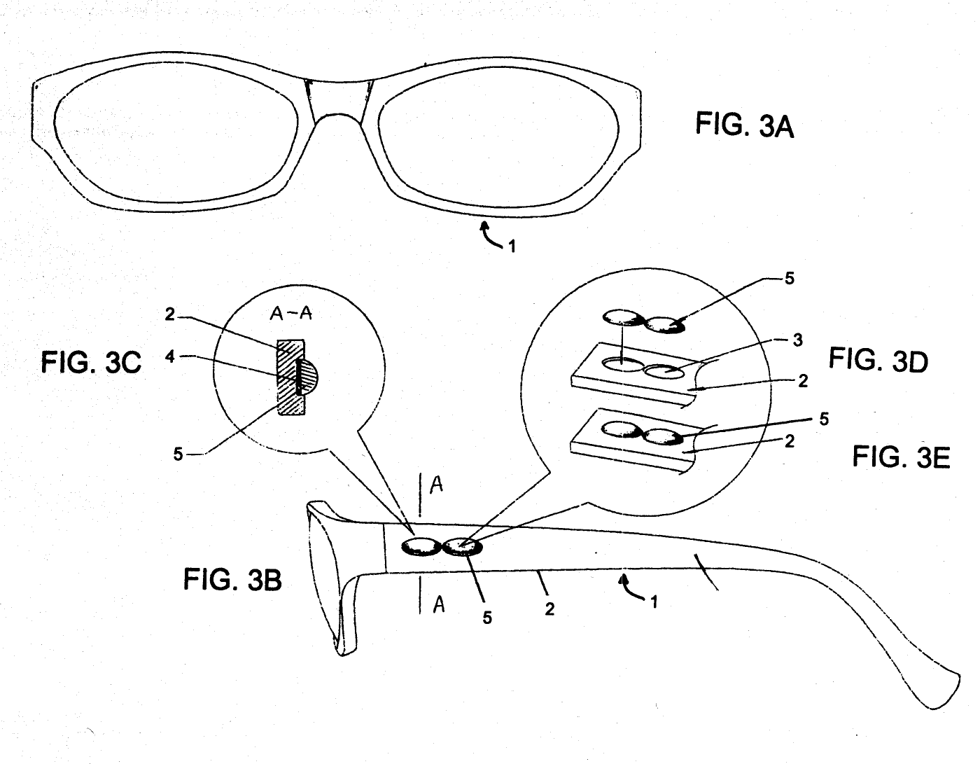

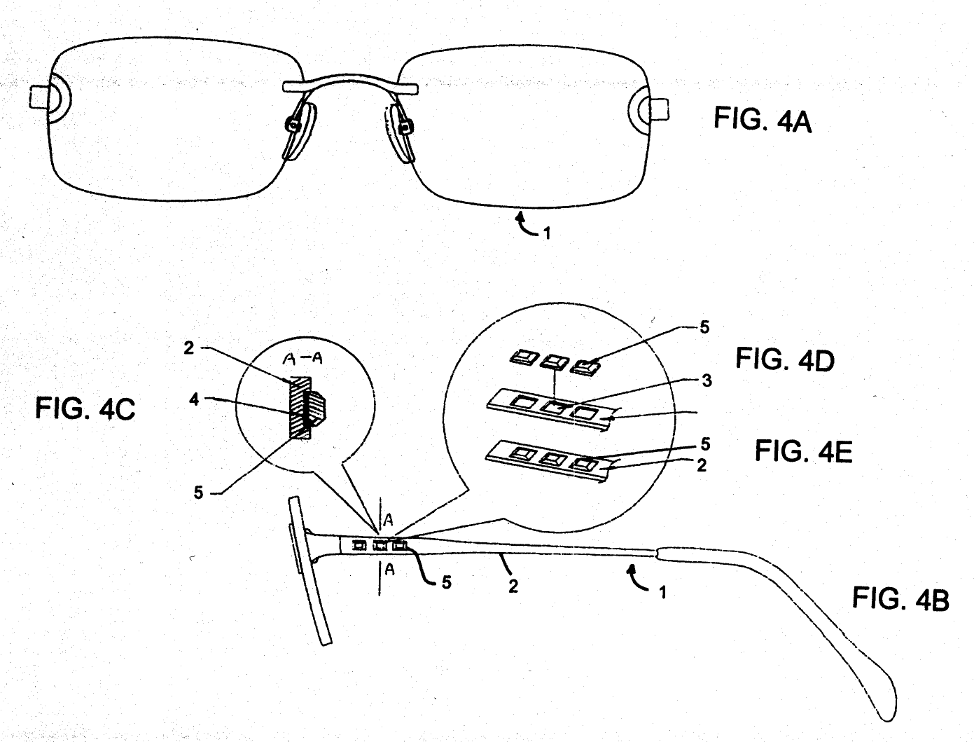

### DETAILED DESCRIPTION

In all the figures of the drawing, sub-features and integral parts that correspond to one another bear the same reference symbol in each case.

Referring now to the figures of the drawings in detail and first, there is shown eyewear 1. The eyewear 1 has two temples 2. Sockets 3 are formed along the exterior of the temples 2. Glue 4 is placed in the indentation. A semiprecious stone 5 complementing the sockets 3 are inserted into the sockets and held by the glue 4

1. Eyewear, comprising:
a temple having sockets formed therein; and
a semiprecious stone set in said socket and connected to said temple.

2. The eyewear according to claim 1, further comprising glue in said socket holding said semiprecious stone in said socket.

3. The eyewear according to claim 1, wherein said semiprecious stone is selected from the group consisting of actinolite, adulite/chrysocolla, African bloodstone, African jade, agate, enydritic, amazonite agate, amber, ametrine, amethyst, amethyst lace, ammolite, antlerite, aquamarine, aragonite, azurite, black onyx, bloodstone/fancy jasper, blue agate, blue chalcedony, blue howlite, blue lace agate, blue sandstone, Botswana agate, brazil agate, brecciated jasper, Burma jade, burned jade, calcite, calcite yellow, cape amethyst, carnelian, cat's eye/opal, charoite, Chinese turquoise, Chinese writing, chyrosprase, citrine, citrite/smoky quartz, cloisonne, coffee jasper, coral, crazy lace agate, crystal, dalmetian, diopside, dumortierite, dyed lapis, dyed turquoise, epidote/unikite, fancy opaline jasper, flower jasper, fossil, garnet, golden sand stone, graphite, green agate, green & pink moss agate, green aventurine, green fluorite, hemachate, hematite, hicorite, honey amber, Indian agate, iolite, ivory, Korean jade, kunzite, kyanite, labradorite, lapis, layer agate, lepidolite, malachite, marquesite, meteorite/iron nickel, mica, moldavite, moonstone, natural agate, nephrite. new jade/serpentine, night shine shell, obsidian, ocean jasper, peach flower, peacock shell, pearl, Peking jade, peridot, petrified wood, phantom quartz, picture jasper, pietersite, polka-dot agate, poppy jasper, purple fluorite, pyrite, rainbow fluorite, rainbow jasper, red aventurine, red jade/balas, red jasper, rhodochrosite (brown), rhodochrosite (pink), rhodolite, rhodonite, rock crystal, rose quartz, rubyzucite, rutilated quartz, rhyolite, sardonyx, skeletal crystal, sky blue agate, snow flakes, snow quartz, sodalite, strawberry quartz, sugilite, sunset jasper, super seven, tiger iron, tiger's eye, topaz/yellow jade, tourmaline, tree agate, tsavorite, turquoise, white howlite, white jade, yellow jasper, yellow lace, and zebra jasper.
